(19) United States
(12) Patent Application Publication
(10) Pub. No.: US 2007/0105599 A1
(43) Pub. Date: May 10, 2007

(54) Assembly of a wireless earphone device and a charging base

(75) Inventor: Tau-Jeng Hsu, Taipei City (TW)

Correspondence Address: OSTROLENK FABER GERB & SOFFEN, 1180 AVENUE OF THE AMERICAS, NEW YORK, NY, 100368403, US

(73) Assignee: Asoka Inc.

(21) Appl. No.: 11/269,036

(22) Filed: Nov. 8, 2005

(51) Int. Cl. H04B 1/38

(52) U.S. Cl. 455/573

(57) ABSTRACT

In an assembly of a wireless earphone device and a charging base, the wireless earphone device includes a controller coupled electrically to a wireless transceiver unit, an earphone speaker and an earphone microphone, and a rechargeable power supplying unit coupled electrically to the controller and an earphone connector port. The charging base includes a base connector port coupled electrically to a power supplying module and a sound source module. The wireless earphone device operates in a charging mode in response to connection of the earphone connector port to the base connector port, in which the rechargeable power supplying unit is charged by the power supplying module through the earphone and base connector ports, and in which the controller directs incoming signals intended for the earphone speaker to the sound source module through the earphone and base connector ports so as to be audibly reproduced by the sound source module.

### BACKGROUND OF THE INVENTION

1. Field of the Invention

The invention relates to an assembly of a wireless earphone device and a charging base, more particularly to an assembly of a wireless earphone device and a charging base that is capable of audibly reproducing incoming audio signals intended for the earphone device when the latter is in a charging mode.

2. Description of the Related Art

With the improvement and stability of wireless communications techniques and quality, wireless earphones for use in conjunction with consumer electronic products, such as cellular phones and stereo systems, have found widespread applications. Examples are Bluetooth earphones, infrared earphones, etc.

Wireless earphones are generally powered by rechargeable batteries. When recharging is desired, the rechargeable batteries are recharged by a charging current through connection with a transformer or a USB cable, or through a battery charger. However, the wireless earphones are not available for use during the charging process, which can result in inconvenience to the user.

### SUMMARY OF THE INVENTION

Therefore, an object of the present invention is to provide an assembly of a wireless earphone device and a charging base that has a sound source module to audibly reproduce incoming audio signals intended for the wireless earphone device when the latter is in a charging mode.

Another object of the present invention is to provide an assembly of a wireless earphone device and a charging base that can charge the wireless earphone device through a battery unit.

Still another object of the present invention is to provide an assembly of a wireless earphone device and a charging base that has an audio recording and playback function.

Yet another object of the present invention is to provide an assembly of a wireless earphone device and a charging base that has a digital playback function.

Accordingly, an assembly of this invention includes a wireless earphone device and a charging base. The wireless earphone device includes a controller, a wireless transceiver unit coupled electrically to the controller, an earphone speaker coupled electrically to the controller for reproducing incoming signals, an earphone microphone coupled electrically to the controller for picking up outgoing signals, a rechargeable power supplying unit coupled electrically to the controller, and an earphone connector port coupled electrically to the controller and the rechargeable power supplying unit. The charging base includes a power supplying module, a sound source module, and a base connector port coupled electrically to the power supplying module and the sound source module. The wireless earphone device operates in a charging mode in response to connection of the earphone connector port to the base connector port, in which the rechargeable power supplying unit is charged by the power supplying module through the earphone and base connector ports, and in which the controller directs the incoming signals intended for the earphone speaker to the sound source module through the earphone and base connector ports so as to be audibly reproduced by the sound source module.

According to a second aspect of the present invention, a charging base for a wireless earphone device includes: a power supplying module; a sound source module; and a base connector port coupled electrically to the power supplying module and the sound source module and adapted to be connected electrically to the wireless earphone device so as to enable the power supplying module to supply a charging signal to the wireless earphone device and so as to enable the sound source module to audibly reproduce incoming signals received from the wireless earphone device.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of the first preferred embodiment of an assembly of a wireless earphone device and a charging base according to this invention;

FIG. 2 is a perspective view of the first preferred embodiment;

FIG. 3 is a circuit diagram of a power supplying module of the first preferred embodiment;

FIG. 4 is a circuit diagram of a sound source module of the first preferred embodiment;

FIG. 5 is a schematic block diagram of the audio recording module of the first preferred embodiment; and

FIG. 6 is a schematic block diagram of a charging base of the second preferred embodiment according to this invention.

### DETAILED DESCRIPTION OF THE PREFERRED EMBODIMENTS

Before the present invention is described in greater detail, it should be noted that like elements are denoted by the same reference numerals throughout the disclosure.

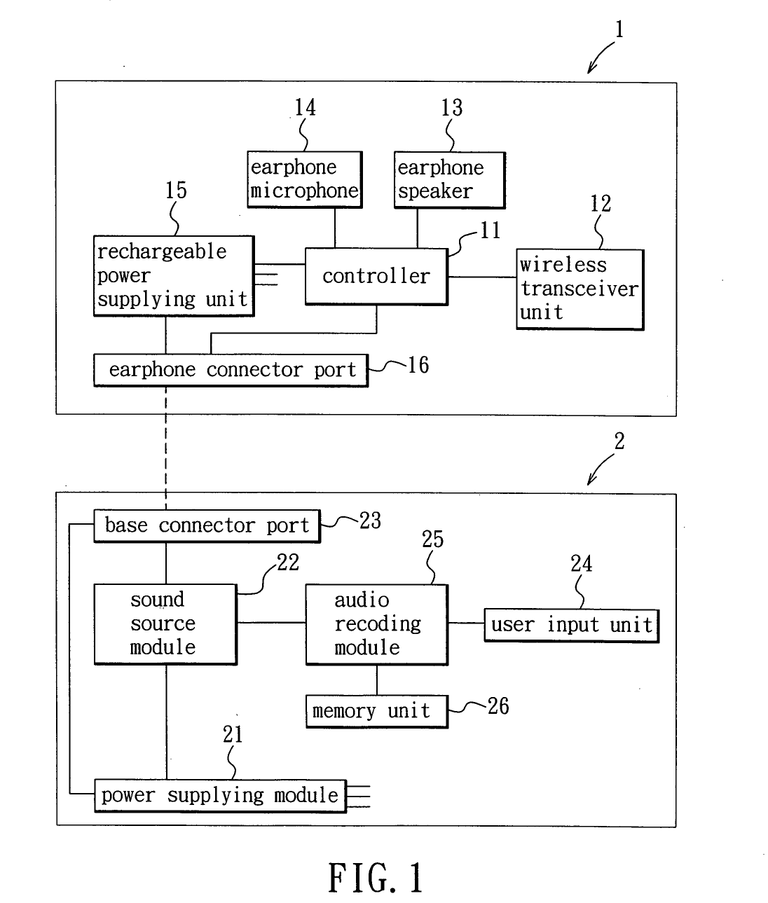

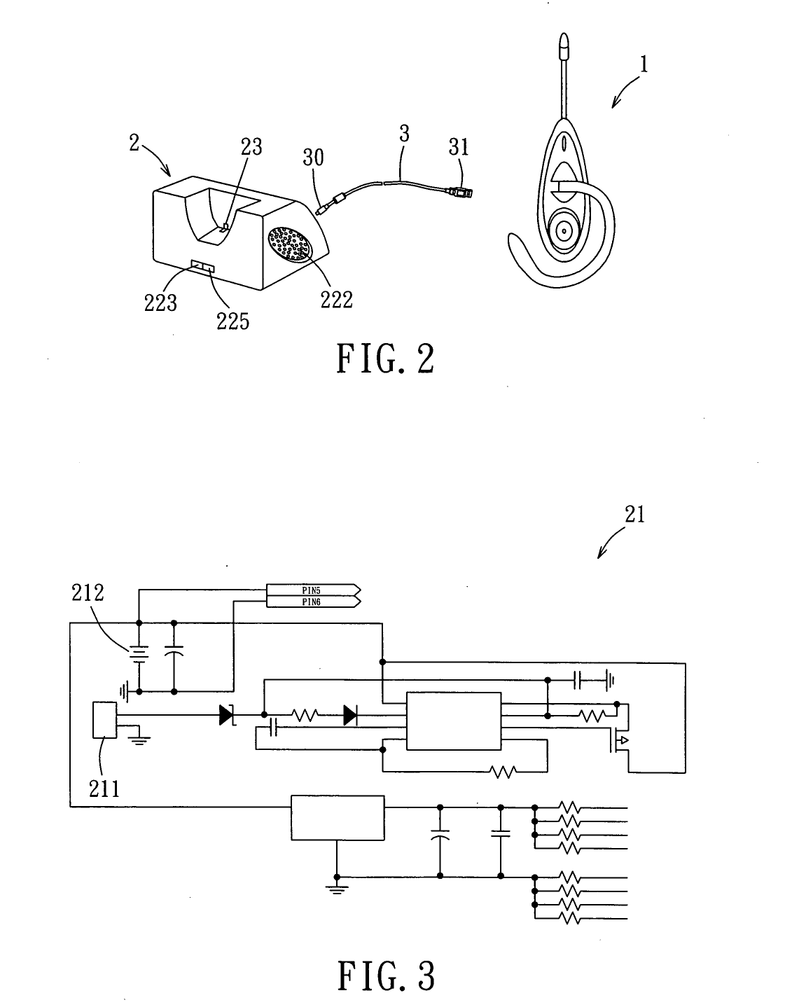

Referring to FIGS. 1 and 2, the first preferred embodiment of an assembly according to the present invention is shown to include a wireless earphone device 1 and a charging base 2.

The wireless earphone device 1 in this embodiment is a high-frequency wireless earphone, such as a Bluetooth wireless earphone. The wireless earphone device 1 includes a controller 11, a wireless transceiver unit 12 coupled electrically to the controller 11 for transmitting and receiving wireless signals, an earphone speaker 13 coupled electrically to the controller 11 for audibly reproducing incoming signals, an earphone microphone 14 coupled electrically to the controller 11 for picking up outgoing signals, a rechargeable power supplying unit 15 for supplying electric power to the controller 11, the wireless transceiver unit 12, the earphone speaker 13, and the earphone microphone 14, and an earphone connector port 16 coupled electrically to the controller 11 and the rechargeable power supplying unit 15.

Specifically, when the wireless transceiver unit 12 receives an incoming audio signal in the form of a wireless signal, the wireless transceiver unit 12 converts the same to an electric signal for transmission to the controller 11. The controller 11 then converts the incoming audio signal into analog form, and transmits the same to the earphone speaker 13. When the user speaks, the earphone microphone 14 converts the sounds picked up thereby to an outgoing audio signal in the form of an electric signal, and transmits the same to the controller 11. The controller 11 then digitizes the outgoing audio signal for transmission to the wireless transceiver unit 12 so as to convert the outgoing audio signal, which is in the form of a digitized electric signal, to a wireless signal for subsequent transmission.

The charging base 2 in this embodiment includes a power supplying module 21, a sound source module 22, and a base connector port 23 coupled electrically to the power supplying module 21 and the sound source module 22.

The wireless earphone device 1 operates in a charging mode in response to connection of the earphone connector port 16 to the base connector port 23, in which the rechargeable power supplying unit 15 is charged by the power supplying module 21 through the earphone and base connector ports 16, 23, and in which the controller 11 directs the incoming signals intended for the earphone speaker 13 to the sound source module 22 through the earphone and base connector ports 16, 23 so as to be audibly reproduced by the sound source module 22.

Since the earphone connector port 16 is coupled electrically to the controller 11 and the rechargeable power supplying unit 15, external charging power can be transmitted to the rechargeable power supplying unit 15 via the earphone connector port 16 so that the rechargeable power supplying unit 15 can use the charging power for charging and for supplying the wireless earphone device 1 with the necessary power (e.g., the power required by the controller 11 and the wireless transceiver unit 12) to ensure continued operation of the wireless earphone device 1 in the charging mode. The controller 11 can selectively transmit the incoming audio signals to the earphone connector port 16 or the earphone speaker 13 for playback, and can selectively receive the outgoing audio signals from the earphone connector port 16 or the earphone microphone 14. In this embodiment, when the earphone connector port 16 of the wireless earphone device 1 is coupled electrically to the charging base 2, i.e., the wireless earphone device 1 operates in the charging mode, the controller 11 is set to transmit and receive incoming and outgoing audio signals to and from the earphone connector port 16.

In this embodiment, the base connector port 23 and the earphone connector port 16 are 10-pin electrical connectors. However, the base connector port 23 and the earphone connector port 16 may be electrical connectors with a different number of pins, and should not be limited to that which is disclosed herein.

The power supplying module 21 supplies the charging base 2 with the necessary power, and generates a charging signal required for charging the wireless earphone device 1. Specifically, referring to FIG. 3, the power supplying module 21 of this embodiment has a charging port 211 adapted to be connected to an external power source (such as a 6V direct current source), and includes a replaceable battery unit 212. Referring back to FIG. 2, the power supplying module 21 may be connected to one end 30 of a power cable 3 through the charging port 211. The other end 31 of the power cable 3 is terminated by a USB connector for connection to a USB interface of an electronic device (not shown) such that the power supplying module 21 can utilize the power of the electronic device. The power supplying module 21 converts the power coming from the external power source or the replaceable battery unit 212 into power required by the wireless charging base 2, and generates the charging signal of 10V, for instance, for the wireless earphone device 1. Two ends of the replaceable battery unit 212 are connected electrically to Pin 5 and Pin 6 of the base connector port 23 so as to output the charging signal through Pin 5 and Pin 6. Certainly, Pin 5 and Pin 6 of the earphone connector port 16 are also connected electrically to the rechargeable power supplying unit 15.

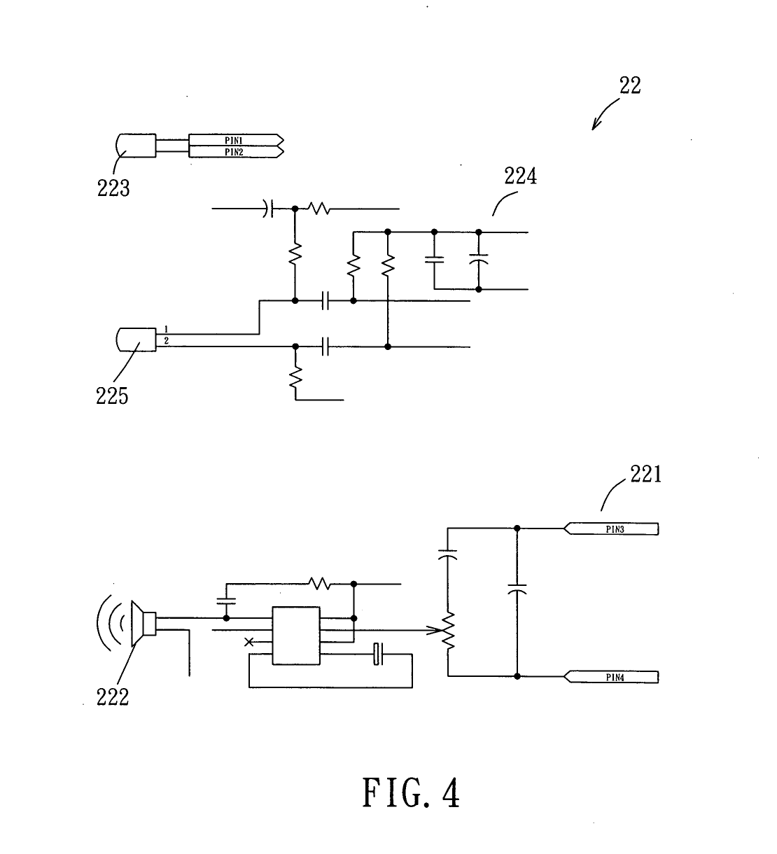

Referring to FIG. 4, the sound source module 22 in this embodiment includes an audio reproducing circuit 221 having a speaker 222. Pin 3 and Pin 4 (not shown) of the earphone connector port 16 are connected electrically to the controller 11 such that the controller 11 is able to direct the incoming audio signals to the sound source module 22 when the wireless earphone device 1 operates in the charging mode. The audio reproducing circuit 221 is connected to Pin 3 and Pin 4 of the base connector port 23. The audio reproducing circuit 221 receives the incoming audio signals from the wireless earphone device 1, and transmits the processed audio signals to the speaker 222 for playback. Furthermore, Pin 1 and Pin 2 (not shown) of the earphone connector port 16 are connected electrically to the controller 11 such that the controller 11 is able to receive outgoing audio signals from the charging base 2 when the wireless earphone device 1 operates in the charging mode. The sound source module 22 further includes a base microphone 223 connected electrically to Pin 1 and Pin 2 of the base connector port 23. The base microphone 223 picks up the user's voice that serves as the outgoing audio signals directed to the controller 11 through the earphone and base connector ports 16, 23 when the wireless earphone device 1 is operated in the charging mode.

When the earphone connector port 16 of the wireless earphone device 1 is connected electrically to the base connector port 23 of the charging base 2, the charging signal generated by the power supplying module 21 can be transmitted to the rechargeable power supplying unit 15 of the wireless earphone device 1 through Pin 5 and Pin 6 of the base connector port 23 for charging the wireless earphone device 1. At the same time, the controller 11 of the wireless earphone device 1 can transmit the incoming audio signal received by the wireless transceiver unit 12 to the audio reproducing circuit 221 through Pins 3 and Pins 4 of the earphone and base connector ports 16, 23 to be played back by the speaker 222. The outgoing audio signal picked up by the base microphone 223 is transmitted to the controller 11 through Pin 1 and Pin 2 of the earphone and base connector ports 16, 23 to enable the controller 11 to transmit the outgoing audio signal to the wireless transceiver unit 12 for conversion to a wireless signal for subsequent output.

Thus, even if the wireless earphone device 1 is in the charging mode, playback or picking up of audio signals can still proceed using the charging base 2, thereby eliminating the prior art drawback of having to discontinue use of the wireless earphone device 1 during charging. Moreover, the user can utilize the charging base 2 as a speaker or pick-up device for the wireless earphone device 1, thereby avoiding any discomfort caused by prolonged wearing of the wireless earphone device 1, as well as possible adverse effects on the user's auditory organs.

The first preferred embodiment further has a recording and playback function. Referring back to FIG. 1, the charging base 2 further includes a user input unit 24, an audio recording module 25 coupled electrically to the user input unit 24, and a memory unit 26 coupled electrically to the audio recording module 25 and adapted to store data for subsequent access by the audio recording module 25. The memory unit 26 in this embodiment is a flash memory.

As best shown in FIG. 4, the sound source module 22 further includes a recording microphone 225 and a microphone coupling circuit 224 that interconnects the recording microphone 225 and the audio recording module 25 such that audio signals picked up by the recording microphone 225 can be fed into the audio recording module 25 through the microphone coupling circuit 224. The audio reproducing circuit 221 of the sound source module 22 is also coupled to the audio recording module 25.

The audio recording module 25 is operable in a recording mode in response to user operation of the user input unit 24 for recording the audio signals picked up by the recording microphone 225 in the memory unit 26. The audio recording module 25 is further operable in a playback mode in response to user operation of the user input unit 24 so as to enable the audio reproducing circuit 221 to audibly reproduce the audio signals recorded in the memory unit 26 through the speaker 222.

Preferably, the user input unit 24 includes RECORD, PLAY and STOP pushbuttons (not shown). When the RECORD pushbutton is pressed, a record command is inputted into the audio recording module 25 to place the audio recording module 25 in the recording mode. When the PLAY pushbutton is pressed, a play command is inputted into the audio recording module 25 to place the audio recording module 25 in the playback mode. When the STOP pushbutton is pressed, a stop command is inputted into the audio recording module 25 to stop operation of the audio recording module 25.

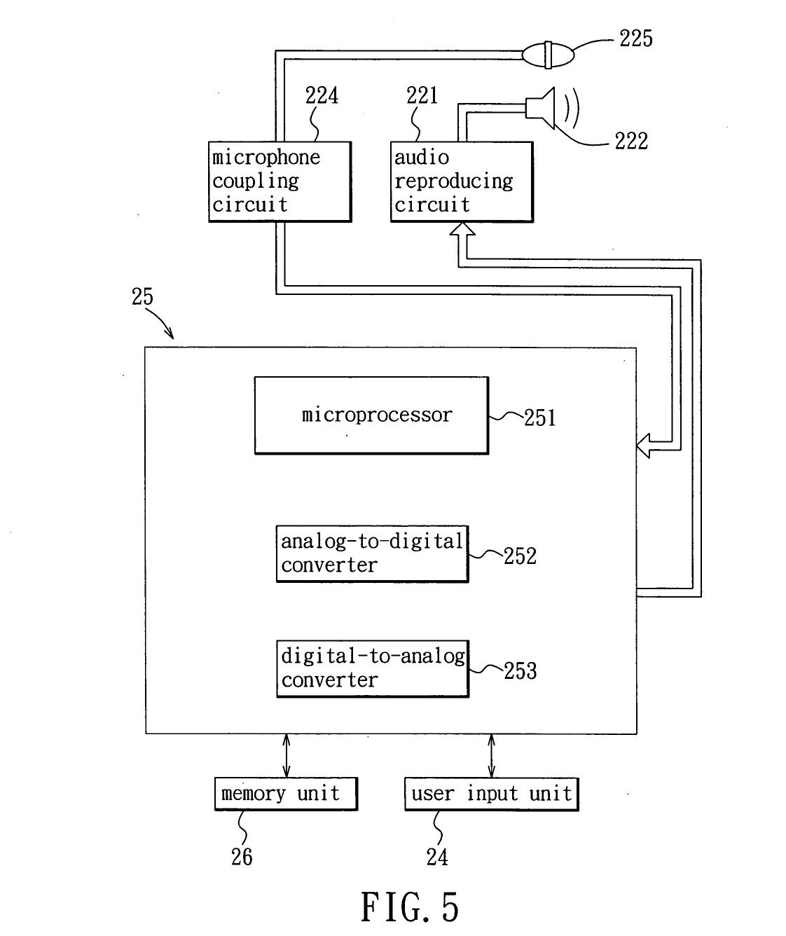

The audio recording module 25 is a chip having an audio signal processing function, such as SPCE061A. Referring to FIG. 5, the audio recording module 25 primarily includes a microprocessor 251, an analog-to-digital converter (ADC) 252 connected electrically to the microphone coupling circuit 224, and a digital-to-analog converter (DAC) 253 connected electrically to the audio reproducing circuit 221.

When the audio recording module 25 receives a record command from the user input unit 24, the recording microphone 225 is able to pick up surrounding sound as audio signals, which are fed into the analog-to-digital converter 252 through the microphone coupling circuit 224. The analog-to-digital converter 252 digitizes the audio signals for transmission to the microprocessor 251. The microprocessor 251 converts the audio signals to sound data for storage in the memory unit 26 to perform a recording operation. If a play command is received, the microprocessor 251 of the audio recording module 25 retrieves the data stored in the memory unit 26, and converts the data to audio signals for transmission to the digital-to-analog converter 253. The digital-to-analog converter 253 converts the audio signals into analog form, and transmits the analog signals to the audio reproducing circuit 221, which transmits the signals to the speaker 222 to play back the retrieved data. The audio recording module 25 will stop operation whenever a stop command is received during the process of a recording or playback operation. The charging base 2 of the first preferred embodiment has a dual function of recording and reproducing sounds.

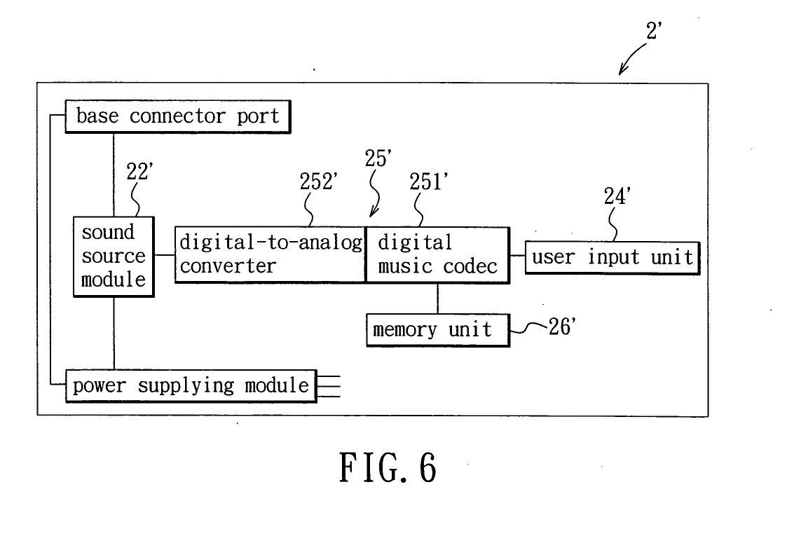

The charging base 2 of this invention may incorporate other functions, such as a digital music playback function, and should not be limited to that which is disclosed hereinabove. Referring to FIG. 6, in the second preferred embodiment of this invention, the charging base 2′ includes a digital playback module 25′, instead of the audio recording module 25. The digital playback module 25′ is coupled electrically to the user input unit 24′, the audio reproducing circuit 221 (see FIG. 4) of the sound source module 22′, and the memory unit 26′. The memory unit 26′ stores a plurality of audio files, such as MP3 music files. In this embodiment, the digital playback module 25′ includes a digital music codec device 251′ for encoding and decoding audio files such as MP3 music files, and a digital-to-analog converter 252′. When the digital playback module 25′ receives a play command inputted by the user through the user input unit 24′, the digital music codec 251′ retrieves the audio files from the memory unit 26′ for decoding, and then transmits the decoded audio files to the digital-to-analog converter 252′, which converts the audio files into analog form for subsequent transmission to the sound source module 22′ for playback. Thus, the user can also utilize the charging base 2′ of the second preferred embodiment as a digital music player.

In sum, not only can the charging base 2, 2′ of this invention be used to charge the wireless earphone device 1, it can also be used to audibly reproduce incoming audio signals intended for the wireless earphone device 1 and to pick up outgoing audio signals for transmission to the wireless earphone device 1 when the wireless earphone device 1 is operated in the charging mode. Besides, the charging base 2, 2′ can serve as a playback and recording medium for the wireless earphone device 1 to eliminate user discomfort due to prolonged wearing of the wireless earphone device 1. In addition, the arrangement of a replaceable battery unit 212 allows for charging of the wireless earphone device 1 in an outdoor environment where an external power source is not readily available. Furthermore, the charging base 2, 2′ is provided with an audio recording module 25 or a digital playback module 25′ to enhance the functionality thereof.
While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An assembly comprising:
a wireless earphone device including a controller, a wireless transceiver unit coupled electrically to said controller, an earphone speaker coupled electrically to said controller for reproducing incoming signals, an earphone microphone coupled electrically to said controller for picking up outgoing signals, a rechargeable power supplying unit coupled electrically to said controller, and an earphone connector port coupled electrically to said controller and said rechargeable power supplying unit; and
a charging base including a power supplying module, a sound source module, and a base connector port coupled electrically to said power supplying module and said sound source module;
said wireless earphone device operating in a charging mode in response to connection of said earphone connector port to said base connector port, in which said rechargeable power supplying unit is charged by said power supplying module through said earphone and base connector ports, and in which said controller directs the incoming signals intended for said earphone speaker to said sound source module through said earphone and base connector ports so as to be audibly reproduced by said sound source module.

2. The assembly as claimed in claim 1, wherein said power supplying module is adapted to be connected to an external power source.

3. The assembly as claimed in claim 1, wherein said power supplying module includes a replaceable battery unit.

4. The assembly as claimed in claim 1, wherein said sound source module includes a base microphone for picking up the outgoing signals that are directed to said controller through said earphone and base connector ports when said wireless earphone device is operated in the charging mode.

5. The assembly as claimed in claim 1, wherein said charging base further includes a user input unit, an audio recording module coupled electrically to said user input unit, and a memory unit coupled electrically to said audio recording module,
said sound source module including a recording microphone and a microphone coupling circuit that interconnects said recording microphone and said audio recording module,
said audio recording module being operable in a recording mode in response to user operation of said user input unit for recording audio signals picked up by said recording microphone in said memory unit,
said sound source module further including an audio reproducing circuit coupled to said audio recording module,
said audio recording module being further operable in a playback mode in response to user operation of said user input unit so as to enable said audio reproducing circuit to audibly reproduce the audio signals recorded in said memory unit.

6. The assembly as claimed in claim 1, wherein said charging base further includes a user input unit, a digital playback module coupled electrically to said user input unit, and a memory unit coupled electrically to said digital playback module for storing audio files,
said sound source module further including an audio reproducing circuit coupled to said digital playback module,
said digital playback module being responsive to user operation of said user input unit so as to enable said audio reproducing circuit to audibly reproduce the audio files stored in said memory unit.

7. A charging base for a wireless earphone device, said charging base comprising:
a power supplying module;
a sound source module; and
a base connector port coupled electrically to said power supplying module and said sound source module and adapted to be connected electrically to the wireless earphone device so as to enable said power supplying module to supply a charging signal to the wireless earphone device and so as to enable said sound source module to audibly reproduce incoming signals received from the wireless earphone device.

8. The charging base as claimed in claim 7, wherein said power supplying module is adapted to be connected to an external power source.

9. The charging base as claimed in claim 7, wherein said power supplying module includes a replaceable battery unit.

10. The charging base as claimed in claim 7, wherein said sound source module includes a base microphone for picking up outgoing signals that are directed to the wireless earphone device when said base connector port is connected electrically to the wireless earphone device.

11. The charging base as claimed in claim 7, further comprising:
a user input unit;
an audio recording module coupled electrically to said user input unit; and
a memory unit coupled electrically to said audio recording module;
said sound source module including a recording microphone and a microphone coupling circuit that interconnects said recording microphone and said audio recording module;
said audio recording module being operable in a recording mode in response to user operation of said user input unit for recording audio signals picked up by said recording microphone in said memory unit;
said sound source module further including an audio reproducing circuit coupled to said audio recording module;
said audio recording module being further operable in a playback mode in response to user operation of said user input unit so as to enable said audio reproducing circuit to audibly reproduce the audio signals recorded in said memory unit.

12. The charging base as claimed in claim 7, further comprising:
a user input unit;
a digital playback module coupled electrically to said user input unit; and
a memory unit coupled electrically to said digital playback module for storing audio files;
said sound source module further including an audio reproducing circuit coupled to said digital playback module;
said digital playback module being responsive to user operation of said user input unit so as to enable said audio reproducing circuit to audibly reproduce the audio files stored in said memory unit.
